(19) United States
(12) Patent Application Publication
(10) Pub. No.: US 2018/0158368 A1
(43) Pub. Date: Jun. 7, 2018

(54) VISUAL ASSIST METHOD AND VISUAL ASSIST SYSTEM

(71) Applicant: INSTITUTE FOR INFORMATION INDUSTRY, Taipei (TW)

(72) Inventor: Chung-Wei KAN, Taipei City (TW)

(21) Appl. No.: 15/372,373

(22) Filed: Dec. 7, 2016

(30) Foreign Application Priority Data
Dec. 7, 2016 (TW) 105140494

(51) Int. Cl. G09B 21/00; G10L 13/08; G06F 17/30; G06N 99/00

(52) U.S. Cl. CPC G09B 21/006; G10L 13/08; G09B 21/008; G06F 17/30752; G06N 99/005; G06F 17/30958

(57) ABSTRACT

A visual assist system includes a database and a processor. The database is coupled to the processor and configured to store text data records and graph data. The text data records are corresponding to the graph data. The processor receives a captured data and determines whether the captured data is one of a graph and a video. If the captured data is determined as the graph, the processor determines whether the captured data is similar to one of the graph data. If the processor determines that the captured data is similar to a first graph data in the graph data, the processor generates a first text data that describes the graph according to a text data record corresponding to the first graph data in the database. The processor assembles the first text data to generate a descriptive text, and sends the descriptive text to a portable electronic device.

### RELATED APPLICATIONS

This application claims priority to Taiwan Application Serial Number 105140494, filed Dec. 7, 2016, which is herein incorporated by reference.

### BACKGROUND

### Technical Field

The present invention relates to a visual assist technology. More particularly, the present invention relates to a visual assist system and a visual assist method.

### Description of Related Art

Visually impaired people are difficult to identify environment and search an object independently in their life. Specifically, most of visually impaired people depend on hearing in their life, and therefore a voice speaking service is necessary to overcome the inconvenience resulted from lack of vision. In the prior art, a real-time video connection can be built between a volunteer and the visually impaired people, and the volunteer questions of the visually impaired people to provide the voice speaking service. However, it depends on a lot of volunteers. It is an important and urgent technological topic in the art to reduce cost of the volunteers and improve effects of the voice speaking service to the visually impaired people.

### SUMMARY

An aspect of the present disclosure is a visual assist method executed by a processor. The visual assist method includes steps as follows. A captured data is received and a determination is made whether the captured data is one of a graph and a video by the processor. A determination is made whether the captured data is similar to one of a plurality of graph data in a database by the processor if the captured data is determined as the graph. A plurality of first text data that describe the graph according to a text data record corresponding to a first graph data stored in the database are generated by the processor if the processor determines that the captured data is similar to the first graph data of the graph data. The first text data are assembled to generate a descriptive text by the processor. The descriptive text comprises at least one of quantity, color, shape and size information of at least one object in the graph. The descriptive text is sent to a portable electronic device by the processor.

Another aspect of the present disclosure is a visual assist system. The visual assist system includes a database and a processor. The database is coupled to the processor and configured to store a plurality of text data records and a plurality of graph data. The text data records are corresponding to the graph data. The processor is configured to receive a captured data, determine whether the captured data is one of a graph and a video, determine whether the captured data is similar to one of the graph data if the captured data is determine as the graph, and generate a plurality of first text data that describe the graph according to a text data record corresponding to a first graph data stored in the database if the processor determines that the captured data is similar to the first graph data of the graph data. The processor is configured to assemble the first text data to generate a descriptive text and send the descriptive text to a portable electronic device. The descriptive text comprises at least one of quantity, color, shape and size information of at least one object in the graph.

In conclusion, the present disclosure can respectively process the graph or the video captured by the user, return the abundant descriptive text (e.g., at least one of quantity, color, shape and size information of the object) about the surrounding environment to the user's portable electronic device and convert the descriptive text to the descriptive audio. Therefore, the user with poor eyesight can understand the surrounding environment and identify objects through the descriptive audio. Moreover, in a situation where the video is unrecognizable, the present disclosure can provide service of identifying environment in real time to the user through the real-time video communication.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a visual assist system according to an embodiment of the present disclosure;

FIG. 2 is a flow chart of a visual assist method according to an embodiment of the present disclosure; and

FIG. 3 is a flow chart of a visual assist method according to an embodiment of the present disclosure.

### DETAILED DESCRIPTION

In order to make the description of the disclosure more detailed and comprehensive, reference will now be made in detail to the accompanying drawings and the following embodiments. However, the provided embodiments are not used to limit the ranges covered by the present disclosure; orders of step description are not used to limit the execution sequence either. Any devices with equivalent effect through rearrangement are also covered by the present disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

In this document, the term “coupled” may also be termed as “electrically coupled,” and the term “connected” may be termed as “electrically connected.” “Coupled” and “connected” may also be used to indicate that two or more elements cooperate or interact with each other.

Unless otherwise indicated, all numbers expressing quantities, conditions, and the like in the instant disclosure and claims are to be understood as modified in all instances by the term “about.” The term “about” refers, for example, to numerical values covering a range of plus or minus 20% of the numerical value. The term “about” preferably refers to numerical values covering range of plus or minus 10% (or most preferably, 5%) of the numerical value. The modifier “about” used in combination with a quantity is inclusive of the stated value.

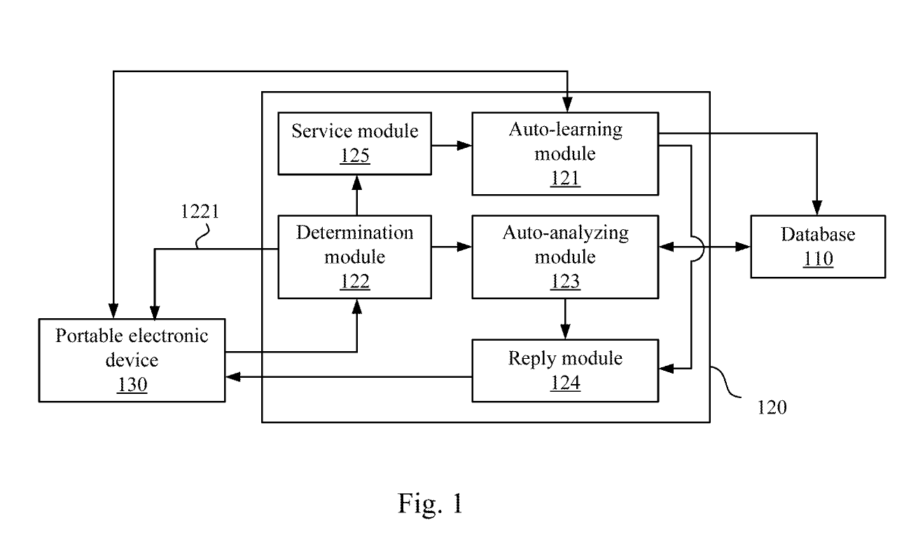

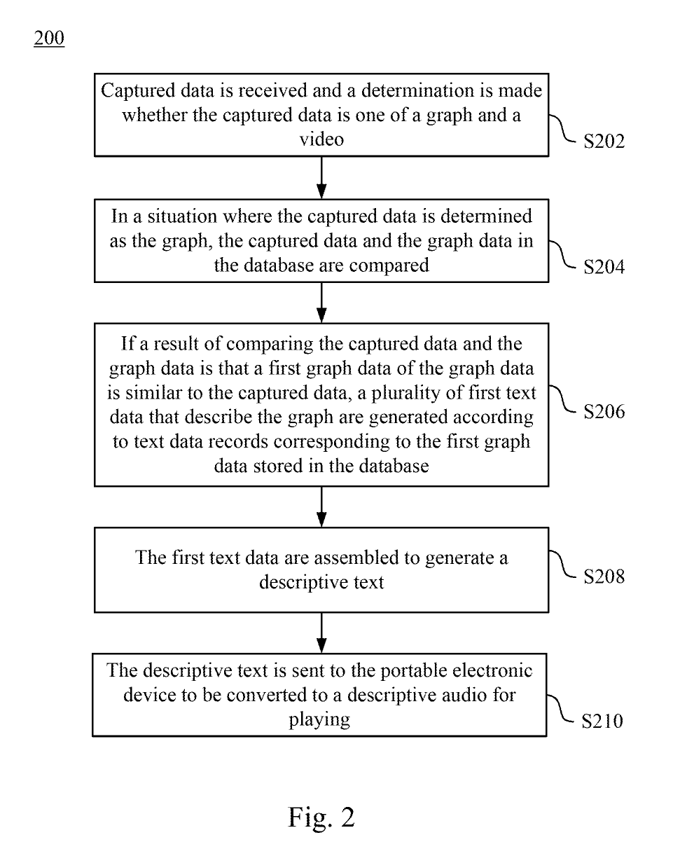

Reference is made to FIGS. 1 and 2. FIG. 1 is a schematic diagram of a visual assist system according to an embodiment of the present disclosure. The visual assist system includes a database 110 and a processor 120. The database 110 is coupled to the processor 120 and configured to store a plurality of text data records and a plurality of graph data. The text data records are corresponding to the graph data. For example, the text data records may be texts that describe characteristics (e.g., at least one of quantity, color, shape and size) of an object in the graph data.

In an embodiment, the processor 120 can be configured to execute an auto-learning module 121, a determination module 122, an auto-analyzing module 123, a reply module 124 and a service module 125. The auto-learning module 121, the determination module 122, the auto-analyzing module 123, the reply module 124 and the service module 125 may be program code modules. However, the present disclosure is not limited thereto.

Reference is made to FIG. 2. FIG. 2 is a flow chart of a visual assist method 200 according to an embodiment of the present disclosure. The visual assist method 200 includes steps S202-S210, and the visual assist method 200 can be applied to the visual assist system 100 as shown in FIG. 1. However, those skilled in the art should understand that the mentioned steps in the present embodiment are in an adjustable execution sequence according to the actual demands except for the steps in a specially described sequence, and even the steps or parts of the steps can be executed simultaneously.

In a situation of application, in order to identify a surrounding environment, a user can use a portable electronic device 130 (e.g., a cell phone, a tablet PC, a smart watch, a portable computer, etc.) to take a picture or record a video to generate captured data (e.g., a graph or a video), and send the captured data to the processor 120 for identification. The processor 120 receives the captured data sent by the portable electronic device 130 and executes the determination module 122 to determine whether the captured data is one of a graph and a video in step S202.

In a situation where the captured data is determined as the graph, the processor 120 executes the auto-analyzing module 123 to compare the captured data and the graph data in the database 110 in step S204. If a result of comparing the captured data and the graph data in step S204 is that a first graph data of the graph data is similar to the captured data, the processor 120 executes the auto-analyzing module 123 to generate a plurality of first text data that describe the graph (e.g., at least one of quantity words, color words, shape words and size words that describe an object, a person or an environment in the first graph) according to text data records corresponding to the first graph data stored in the database in step S206.

In step S208, the processor 120 executes the auto-analyzing module 123 to assemble the first text data to generate a descriptive text. It should be noted that the descriptive text includes at least one quantity, color, shape and size information of at least one object in the graph, and the descriptive text is a description that meets a specific rule (e.g., with a specific describing order and desired contents). In other words, the processor 120 executes the auto-analyzing module 123 to assemble the first text data to generate the descriptive text according to the specific rule in step S208. Then, the processor 120 executes the reply module 124 to send the descriptive text to the portable electronic device 130 to convert to a descriptive audio for playing in step S210. For example, the user executes an application to send the captured data (e.g., the graph or the video) to the processor 120, and receives the descriptive text from the processor 120 to convert the descriptive text to the descriptive audio for playing through the portable electronic device 130.

For example, the specific rule includes but is not limited to rules as follows. In a rule regarding to quantity of objects in the graph, a person and an object near the person are described first, or a large object is described first, or the objects are described from top to bottom and from left to right of the graph. In a rule regarding to colors of the objects in the graph, words “deep red,” “pale red” or words “lipstick,” “apple,” “strawberry,” “blood” may be used to describe the colors. In a rule regarding to shapes of the objects in the graph, words “circular,” “rectangular” or words “tire,” “blackboard” may be used to describe the shapes. In a rule regarding to sizes of the objects in the graph, a finger, a fist or an arm may be taken as a unit to describe the sizes.

As a result, the user merely needs to capture a graph of the surrounding environment so that the present disclosure can generate the abundant descriptive text (e.g., at least one of quantity, color, shape and size information of the object) about the surrounding environment and convert the descriptive text to the descriptive audio. Therefore, the user with poor eyesight or visual impairment can understand the surrounding environment and identify the object through the descriptive audio.

In contrast, if the result of comparing the captured data and the graph data by the processor 120 in step S204 is that the graph data is not similar to the captured data, the processor 120 receives an external descriptive text that describe the graph. It should be noted that the external descriptive text may be entered by a trained person. The trained person may enter the external descriptive text according to the aforementioned specific rule. Similarly, the external descriptive text includes at least one of quantity, color, shape and size information of at least one object in the graph. Then, the processor 120 executes the reply module 124 to send the external descriptive text to the portable electronic device 130 to convert to the descriptive audio for playing in step 210.

In an embodiment, the processor 120 can generate the text data records corresponding to the graph through the external descriptive text, store the graph and the text data records in the database 110, and execute the auto-learning module 121 to employ machine-learning through the graph and the text data records. As a result, the processor 120 can improve identification accuracy by employing machine-learning.

Regarding to step S204 of comparing the captured data and the graph data in the database in the situation where the captured data is determined as the graph, in an embodiment, the processor 120 execute the auto-analyzing module 123 to first divide the graph into a plurality of subgraphs, and then respectively compare each of the subgraphs and the graph data in the database 110. If a result of comparing the each of the subgraphs and the graph data is that a second graph data of the graph data is similar to a first subgraph of the subgraphs, the processor 120 executes the auto-analyzing module 123 to generate a plurality of second text data that describe the first subgraph according to text data records corresponding to the second graph data stored in the database 110, and then generate the first text data that describes the graph according to all the second text data generated from the subgraphs.

As a result, the processor 120 can generate the first text data that describe all objects in the graph by comparing the subgraphs divided from the graph, and further assemble the first text data to generate the abundant descriptive text (e.g., at least one of quantity, color, shape and size information of the objects) about the surrounding environment.

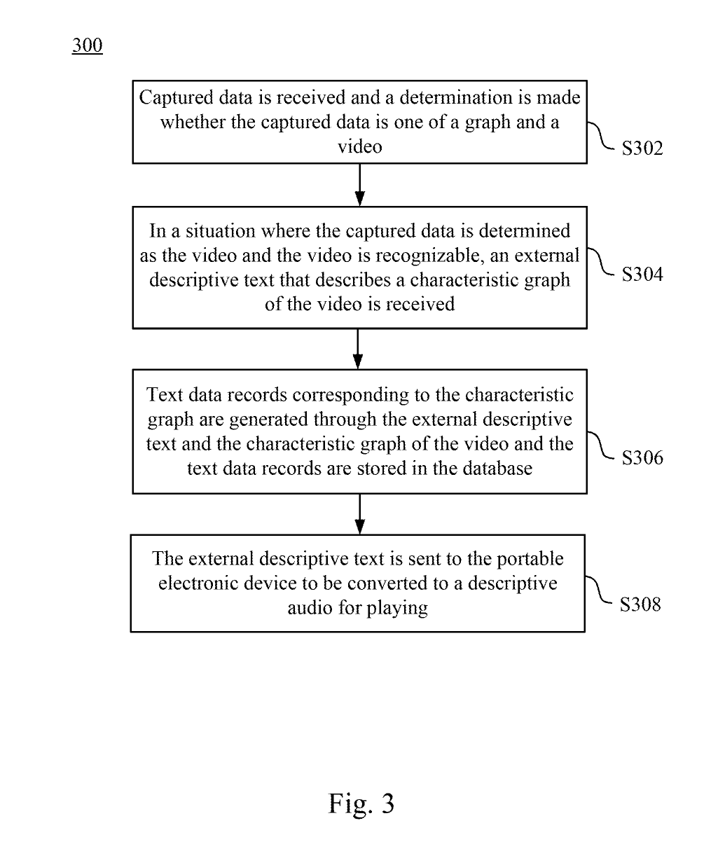

In order to describe a situation where the captured data is a video, reference is made to FIGS. 1 and 3. FIG. 3 is a flow chart of a visual assist method 300 according to an embodiment of the present disclosure. The visual assist method 300 includes steps S302-S308, and the visual assist method 300 can be applied to the visual assist system 100 as shown in FIG. 1. However, those skilled in the art should understand that the mentioned steps in the present embodiment are in an adjustable execution sequence according to the actual demands except for the steps in a specially described sequence, and even the steps or parts of the steps can be executed simultaneously.

The processor 120 receives the captured data sent from the portable electronic device 130, and execute the determination module 122 to determine whether the captured data is one of the graph or the video in step S302. It should be noted that processor 120 is configured to execute the determination module 122 to determine whether the video is recognizable in the situation where the captured data is determined as the video.

In step S304, in a situation where the captured data is determined as the video and the video is recognizable, the processor 120 executes the service module 125 to receive an external descriptive text that describes a characteristic graph of the video. Specifically, the trained person may determine a representative frame in the video as the characteristic graph, and enter the external descriptive text that describe the characteristic graph through an interface provided by the service module 125. The trained person may enter the external descriptive text according to the aforementioned specific rule. Similarly, the external descriptive text includes at least one of quantity, color, shape and size information of at least one object in the graph.

In step S306, the processor 120 generates text data records corresponding to the characteristic graph through the external descriptive text, and store the characteristic graph of the video and the text data records in the database 110. Similarly, the processor 120 can also execute the auto-learning module 121 to employ machine-learning through the characteristic graph of the video and the text data records. As a result, the processor 120 can improve identification accuracy by employing machine-learning. Then, the processor 120 executes the reply module 124 to send the external descriptive text to the portable electronic device 130 to convert to the descriptive audio for playing in step S308.

In contrast, in a situation where the captured data is determined as the video and the video is unrecognizable (e.g., the video is blurred) by the determination module 122 executed by the processor 120, the processor 120 can directly connect to the portable electronic device 130 to provide a real-time video communication 1221 (e.g., a video call) to the user that needs the help. For example, the trained person may directly communicate with the user that needs the help through the real-time video communication 1221 in order to provide a service of identifying environment in real time.

As a result, the user may use the portable electronic device 130 to record the surrounding environment, and the present disclosure can send the abundant descriptive text (e.g., at least one of quantity, color, shape and size information of the object) about the surrounding environment to the user's portable electronic device 130 for converting to the descriptive audio in the situation where the video is recognizable, and provides environment identification in real time to the user through the real-time video communication 1221 service in the situation where the video is unrecognizable.

It should be noted that steps S208 and S308 of the present disclosure may be implemented as above description, however, the present disclosure is not limited thereto. In an embodiment, the portable electronic device 130 may convert the descriptive text sent by the processor 120 to the descriptive audio and play the descriptive audio. Alternatively, in another embodiment, the processor 120 may convert the descriptive text to the descriptive audio and send the descriptive audio to the portable electronic device 130 for playing.

In practice, the database 110 can be stored in a storage device, such as a hard disk, any non-transitory computer readable storage medium, or a database accessible from network. Those of ordinary skill in the art can think of the appropriate implementation of the database 110 without departing from the spirit and scope of the present disclosure. The processor 120 may be a central processing unit (CPU), a microprocessor or a cloud server.

The above-mentioned auto-learning module 121, the determination module 122, the auto-analyzing module 123, the reply module 124 and the service module 125 can be implemented as software, hardware and/or firmware. For example, if the execution speed and accuracy is a primary consideration, then each module and each unit can be mainly selected from hardware and/or software; if the design flexibility is a primary consideration, then each module and each unit can be mainly selected from software; and alternatively, each module and each unit can make use of software, hardware and firmware cooperatively. It should be known that, the above-mentioned examples are not classified as better or worse and they are not used to limit the invention. Those of skills in the art can flexibly select the specific implementation for each module and each unit, depending on the current demand. In an embodiment, the auto-learning module 121, the determination module 122, the auto-analyzing module 123, the reply module 124 and the service module 125 can be integrated into a central processing unit (CPU). Alternatively, in another embodiment, the auto-learning module 121, the determination module 122, the auto-analyzing module 123, the reply module 124 and the service module 125 may be computer programs that are stored in a storage device, and the computer programs includes a plurality of program instructions. The program instructions can be executed by the CPU so that the electricity consumption predicting system performs functions of the above modules.

In conclusion, the present disclosure can respectively process the graph or the video captured by the user, return the abundant descriptive text (e.g., at least one of quantity, color, shape and size information of the object) about the surrounding environment to the user's portable electronic device 130 and convert the descriptive text to the descriptive audio. Therefore, the user with poor eyesight can understand the surrounding environment and identify objects through the descriptive audio. Moreover, in a situation where the video is unrecognizable, the present disclosure can provide service of identifying environment in real time to the user through the real-time video communication 1221.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A visual assist method executed by a processor, wherein the visual assist method comprises steps as follows:
by the processor, receiving a captured data and determining whether the captured data is one of a graph and a video;
by the processor, determining whether the captured data is similar to one of a plurality of graph data in a database if the captured data is determined as the graph;
by the processor, generating a plurality of first text data that describe the graph according to a text data record corresponding to a first graph data stored in the database if the processor determines that the captured data is similar to the first graph data of the graph data;
by the processor, assembling the first text data to generate a descriptive text, wherein the descriptive text comprises at least one of quantity, color, shape and size information of at least one object in the graph; and
by the processor, sending the descriptive text to a portable electronic device.

2. The visual assist method of claim 1, further comprising:
by the portable electronic device, converting the descriptive text to a descriptive audio and playing the descriptive audio.

3. The visual assist method of claim 1, further comprising:
by the processor, converting the descriptive text to a descriptive audio, and sending the descriptive audio to the portable electronic device for playing.

4. The visual assist method of claim 1, further comprising:
in a situation where the captured data is determined as the graph, if the processor determines that the graph data are not similar to the captured data, by the processor, receiving an external descriptive text that describes the graph, wherein the external descriptive text comprises at least one of quantity, color, shape and size information of the at least one object in the graph; and
by the processor, sending the external descriptive text to the portable electronic device to convert to a descriptive audio for playing.

5. The visual assist method of claim 4, further comprising:
by the processor, generating the text data records corresponding to the graph through the external descriptive text, and storing the graph and the text data records in the database; and
by the processor, employing machine-learning through the graph and the text data records.

6. The visual assist method of claim 1, further comprising:
in a situation where the captured data is determined as the video and the video is recognizable, by the processor, receiving an external descriptive text that describes a characteristic graph of the video, wherein the external descriptive text comprises at least one of quantity, color, shape and size information of at least one object the characteristic graph; and
by the processor, sending the external descriptive text to the portable electronic device to convert to a descriptive audio for playing.

7. The visual assist method of claim 6, further comprising:
by the processor, generating the text data records corresponding to the characteristic graph through the external descriptive text, and storing the characteristic graph of the video and the text data records in the database; and
by the processor, employing machine-learning through the characteristic graph of the video and the text data records.

8. The visual assist method of claim 1, further comprising:
in a situation where the captured data is determined as the video and the video is unrecognizable, by the processor, connecting to the portable electronic device to provide a real-time video communication.

9. The visual assist method of claim 1, wherein matching the captured data and the graph data in the database in a situation where the captured data is determined as the graph comprising:
by the processor, first dividing the graph into a plurality of subgraphs, and then matching each of the subgraphs and the graph data in the database; and
by the processor, generating a plurality of second text data that describe a first subgraph according to a text data record corresponding to the second graph data stored in the database if the processor determines that the first subgraph of the subgraphs is similar to a second graph data of the graph data, and then generating the first text data that describe the graph according to all the second text data generated from the subgraphs.

10. A visual assist system, comprising:
a database, configured to store a plurality of text data records and a plurality of graph data, wherein the text data records are corresponding to the graph data; and
a processor, coupled to the database and configured to receive a captured data and determine whether the captured data is one of a graph and a video, determine whether the captured data is similar to one of the graph data if the captured data is determine as the graph, and generate a plurality of first text data that describe the graph according to a text data record corresponding to a first graph data stored in the database if the processor determines that the captured data is similar to the first graph data of the graph data;
wherein the processor is further configured to assemble the first text data to generate a descriptive text and send the descriptive text to a portable electronic device, and the descriptive text comprises at least one of quantity, color, shape and size information of at least one object in the graph.

11. The visual assist system of claim 10, wherein the portable electronic device is configured to convert the descriptive text to a descriptive audio and play the descriptive audio.

12. The visual assist system of claim 10, wherein the processor is further configured to convert the descriptive text to a descriptive audio, and send the descriptive audio to the portable electronic device for playing.

13. The visual assist system of claim 10, wherein the processor is further configured to in a situation where the captured data is determined as the graph, receive an external descriptive text that describes the graph if the processor determines that the graph data are not similar to the captured data, and send the external descriptive text to the portable electronic device to convert to a descriptive audio for playing;
wherein the external descriptive text comprises at least one of quantity, color, shape and size information of the at least one object in the graph.

14. The visual assist system of claim 13, wherein the processor is further configured to generate the text data records corresponding to the graph through the external descriptive text, store the graph and the text data records in the database, and employ machine-learning through the graph and the text data records.

15. The visual assist system of claim 10, wherein the processor is further configured to in a situation where the captured data is determined as the video and the video is recognizable, receive an external descriptive text that describes a characteristic graph of the video, and send the external descriptive text to the portable electronic device to convert to a descriptive audio for playing;
wherein the external descriptive text comprises at least one of quantity, color, shape and size information of at least one object the characteristic graph.

16. The visual assist system of claim 15, wherein the processor is further configured to generate the text data records corresponding to the characteristic graph through the external descriptive text, store the characteristic graph of the video and the text data records in the database, and employ machine-learning through the characteristic graph of the video and the text data records.

17. The visual assist system of claim 10, wherein the processor is further configured to in a situation where the captured data is determined as the video and the video is unrecognizable, connect to the portable electronic device to provide a real-time video communication.

18. The visual assist system of claim 10, wherein the processor is further configured to first divide the graph into a plurality of subgraphs, then match each of the subgraphs and the graph data in the database, generate a plurality of second text data that describe a first subgraph according to a text data record corresponding to the second graph data stored in the database if the processor determines that the first subgraph of the subgraphs is similar to a second graph data of the graph data, and then generate the first text data that describe the graph according to all the second text data generated from the subgraphs.
